(19) United States
(12) Patent Application Publication
(10) Pub. No.: US 2012/0308056 A1
(43) Pub. Date: Dec. 6, 2012

(54) THREE-DIMENSIONAL SOUND APPARATUS

(75) Inventor: Toshiaki NAKAYAMA, Miyoshi-city (JP)

(73) Assignee: DENSO CORPORATION, Kariya-city (JP)

(21) Appl. No.: 13/454,419

(22) Filed: Apr. 24, 2012

(30) Foreign Application Priority Data
Jun. 2, 2011 (JP) 2011-124590
Aug. 9, 2011 (JP) 2011-174003

(51) Int. Cl. H04R 5/02

(52) U.S. Cl. 381/302

(57) ABSTRACT

Binaural recording stored in a reproducing-use sound source portion is recorded by giving an ultrasonic modulated sound from a recording-use ultrasonic wave speaker to a dummy head. A cross talk is suppressed; thus, the binaural recording is obtained with clear sonic localization information while localization of pronunciation orientation can be improved. Further, the sounds generated by ultrasonic modulating the binaural recording in the reproducing-use sound source portion are given towards left and right ears of a driver from left and right reproducing-use ultrasonic wave speaker units, respectively, arranged at positions distant from the head of the driver. “Sonic 3D information” relative to the localization of pronunciation orientation is given accurately to the ears of the driver. Even in a vehicle compartment tending to provide reflected sounds or muffled sounds, an accurate “sonic localization” can be achieved without a headphone.

### CROSS REFERENCE TO RELATED APPLICATION

This application is based on Japanese Patent Applications No. 2011-124590 filed on Jun. 2, 2011 and No. 2011-174003 filed on Aug. 9, 2011, the disclosure of which is incorporated herein by reference.

### TECHNICAL FIELD

The present disclosure relates to a three-dimensional sound apparatus that provides a user with a sonic three-dimensional localization using left and right speaker units (two-channel speaker). The sonic three-dimensional localization enables localization (i.e., specifying a position) of “front/rear,” “front/rear and left/right,” or “front/rear, left/right, and top/bottom”) of a sound.

### BACKGROUND

[Patent document 1] JP H5-153687 A

There is known a technology of “binaural recording+headphone reproduction” in the three-dimensional sound apparatus which provides a user with a sonic three-dimensional localization using two left and right speaker units (see Patent document 1). The binaural recording is recorded by arranging left and right microphone units to left and right dummy ears of a dummy head, respectively. The recorded binaural recording (recording product) is directly reproduced in the left and right ears using a headphone (a speaker that provides direct sounds to the ears: an ear speaker is included). This enables a technology of the sonic three-dimensional localization.

It is not so easy to provide a sound reproduction apparatus to perform a sonic three-dimensional localization. The “binaural recording+headphone reproduction” accords “the position of the microphone (i.e., the position of the dummy ear)” at the time of recording with “the reproduced sound generated position (i.e., the position of a person's ear)” at the time of the reproduction. This enables an accurate reproduction of sonic 3D information (i.e., sound information relative to the sonic three-dimensional localization) in the ear.

However, when “the position of the speaker” and the “ear” separate from each other, a cross talk arises which signifies an event where the sound of the speaker on one side reaches the ear on the opposite side. This makes it impossible to reproduce the “sonic 3D information” in the ear accurately. The accurate “sonic three-dimensional localization” thus becomes difficult. Thus, the “binaural recording+headphone reproduction” predominates in the sound reproduction apparatus which performs an accurate “sonic three-dimensional localization” using the speaker of two channels.

There is recently desired a three-dimensional sound apparatus which enables a sonic three-dimensional localization even when a speaker is arranged in a position distant from a ear without using a headphone. In responding to such a desire, various technologies have been developed which include a cross-talk canceller using a computer to process the left and right signal phases of the stereophonic recording. However, in the three-dimensional sound apparatus which does not use a headphone, the technology of localizing the sound freely at an arbitrary position may be applied only to a large space that does not have reflected sounds or muffled sounds.

### SUMMARY

It is an object of the present disclosure to provide a three-dimensional sound apparatus that enables an accurate “sonic three-dimensional localization” even when “a position of a speaker” and an “ear” are separated distant from each other in a small space such as a vehicle compartment that tends to provide reflected sounds or muffled sounds.

To achieve the above object, according to an aspect of the present disclosure, a three-dimensional sound apparatus is provided as follows. The three-dimensional sound apparatus is provided in a small space including a vehicular compartment tending to provide reflected sounds or muffled sounds. The three-dimensional sound apparatus includes a reproducing-use sound source portion that stores binaural recording of two channels; and a two-channel reproduction portion that reproduces the binaural recording of two channels stored in the reproducing-use sound source portion. Herein, the binaural recording stored in the reproducing-use sound source portion is recorded by generating, from a recording-use ultrasonic wave speaker, an ultrasonic modulated sound that is obtained by applying an ultrasonic modulation to an audible sound. The two-channel reproduction portion applies an ultrasonic modulation to the binaural recording stored in the reproducing-use sound source portion to obtain ultrasonic modulated sounds, and gives the ultrasonic modulated sounds towards left and right ears of a user from left and right reproducing-use ultrasonic wave speaker units arranged at positions distant from a head of the user, respectively.

The ultrasonic wave has a high or strong directionality (i.e., straightness); therefore, the diffusion (cross talk) of the sound may be suppressed. Binaural recording (recording product) using the ultrasonic wave can provide clear sonic localization information. Thus, as compared with an existing binaural recording using a usual sound that is not ultrasonic modulated, the binaural recording using the ultrasonic wave can provide a significantly clear sonic localization.

Further, as mentioned above, since the directionality of the ultrasonic wave is strong, the diffusion of the sound is suppressed; thereby, the “recorded sound” may be given pinpoint to each of the left and right ears. That is, even in a vehicle compartment tending to have reflected sounds or muffled sounds, the “sonic 3D information” may be accurately reproduced at each of the left and right ears of the user.

Thus, under the above configuration of the aspect, even when the reproducing-use ultrasonic wave speaker units and the ears are separated distant from each other, the “sonic 3D information” included in the binaural recording is accurately reproducible at each of the left and right “ears” of the user. Thus, even without using a headphone, the pronunciation orientation may be localized freely at an arbitrary position. That is, even when “a position of a speaker” and an “ear” are separated distant from each other in a small space such as a vehicle compartment that tends to have reflected sounds or muffled sounds, an accurate “sonic three-dimensional localization” can be achieved.

### BRIEF DESCRIPTION OF THE DRAWINGS

The above and other objects, features, and advantages of the present disclosure will become more apparent from the following detailed description made with reference to the accompanying drawings. In the drawings:

FIG. 1A is a block diagram illustrating a configuration of recording components used for binaural recording according to a first example;

FIG. 1B is a diagram illustrating a configuration of a three-dimensional sound apparatus according to the first example;

FIG. 2A, 2B are diagrams for explaining an arrangement of left and right ultrasonic wave speaker units for reproduction according to the first example;

FIG. 3 is a diagram illustrating a frequency characteristic of recording using a dummy head according to the first example;

FIG. 4 is a diagram illustrating a frequency characteristic in an arrangement of left and right ultrasonic wave speaker units for reproduction according to the first example;

FIG. 5A is a diagram for explaining of a caution determined by a caution orientation determination section according to a second example;

FIG. 5B is a diagram for explaining a sonic localization according to the second example;

FIG. 6A is a diagram for explaining of a caution determined by a caution orientation determination section according to a third example;

FIG. 6B is a diagram for explaining a sonic localization according to the third example; and

FIG. 7 is a block diagram illustrating a configuration of recording components used for binaural recording according to a fourth example.

### DETAILED DESCRIPTION

A three-dimensional sound apparatus according to an embodiment of the present disclosure may be applied in a small space such as a vehicle compartment where reflected sounds or muffled sounds tend to arise. The three-dimensional sound apparatus includes the following: a reproducing-use sound source portion 4 which stores binaural recording having two channels recorded using a microphone 3 having a left microphone unit 3L and a right microphone unit 3R arranged at left and right dummy ears 2L, 2R, respectively, of a dummy head 1 that imitates a human body head; and a two-channel reproduction portion 5 to reproduce the binaural recording stored in the reproducing-use sound source portion 4.

The binaural recording (recording product) stored in the sound source portion 4 is recorded by applying an ultrasonic modulation to an audible sound to obtain an ultrasonic modulated sound, and providing the generated ultrasonic modulated sound to the dummy head 1 from a recording-use ultrasonic wave speaker 6 for recording. In addition, the dummy head 1 used for binaural recording has left and right dummy ears 2L, 2R, which have dummy ear pinnas 2La, 2Ra and dummy external auditory canals 2Lb, 2Rb which imitate external ears of a human being. The left and right microphone units 3L, 3R are arranged inside of the dummy external auditory canals 2Lb, 2Rb, respectively.

The two-channel reproduction portion 5 is mounted, e.g., in a vehicle, while applying an ultrasonic modulation to the binaural recording stored in the reproducing-use sound source portion 4, thereby producing ultrasonic modulated sounds. The reproducing-use reproduction portion 5 gives the ultrasonic modulated sounds to left and right ears of the user via the left and right ultrasonic wave speaker units 7L, 7R, respectively, installed at positions distant from a head a of a user such as a driver or occupant. In addition, the left and right ultrasonic wave speaker units 7L, 7R are arranged in an inward swing arrangement, which is defined as an arrangement where two radiation axes of the units 7L, 7R are non-parallel with each other, and directed, towards a position of the driver, inward from the parallel lines.

### First Example

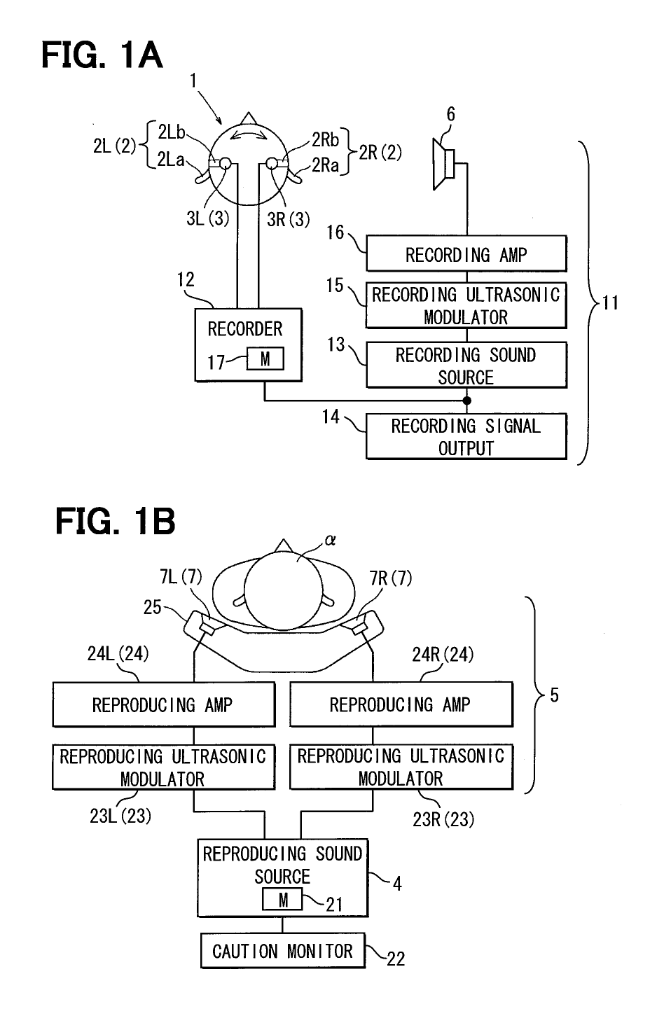

A first example will be explained with reference to FIGS. 1A to 4. In the first example, the three-dimensional sound apparatus is applied to a vehicle-use sound apparatus, i.e., a caution apparatus that provides a driver with “information on orientation” using a speech.

In the present application, “information” that is primarily uncountable is additionally defined as being identical to “information item” that is countable. Thus, “an information” and “informations” are used herein as being identical to “an information item” and “information items,” respectively.

As illustrated in FIG. 1, the caution apparatus includes the following: a reproducing-use sound source portion 4 which stores binaural recording (recording product) having two channels recorded using a microphone 3 having a left microphone unit 3L and a right microphone unit 3R arranged at left and right dummy ears 2L, 2R, respectively, of a dummy head 1 that imitates a human body head; and a two-channel reproduction portion 5 to reproduce the binaural recording stored in the reproducing-use sound source portion 4.

(Explanation of Binaural Recording Stored in the Reproducing-Use Sound Source Portion 4)

The binaural recording (recording product) stored in the sound source portion 4 is recorded by applying an ultrasonic modulation to an audible sound to obtain an ultrasonic modulated sound, and providing the generated ultrasonic modulated sound to the dummy head 1 from a recording-use ultrasonic wave speaker 6 for recording. This will be explained with reference to FIG. 1A. The binaural recording uses a recording-use sound generator 11 which gives a “sound used for recording” to the dummy head 1, and a recorder 12 which records the “sound used for recording” captured using the left and right microphone unit 3L, 3R of the dummy head 1.

The dummy head 1 used for the binaural recording has dummy ears 2L, 2R provided with (i) dummy ear pinnas 2La, 2Ra (earlobes protruded left and right from the head) and (ii) dummy external auditory canals 2Lb, 2Rb (so-called earholes), for imitating people's external ears. The left and right microphone units 3L, 3R are arranged inside of the dummy external auditory canals 2Lb, 2Rb, respectively.

(Explanation of the Recording-Use Sound Generator 11)

The recording-use sound generator 11 gives information on orientation to the dummy head 1; the information on orientation is a speech that is ultrasonic modulated using a parametric speaker. The sound generator 11 includes the following: a recording-use ultrasonic wave speaker 6 that generates an ultrasonic wave in a parametric speaker; a recording-use sound source portion 13 that outputs “several speech signals (information on orientation)”; a recording signal output portion 14 that outputs a “specific speech signal” via the recording-use sound source portion 13; a recording-use ultrasonic modulator 15 that modulates a “speech signal,” which is outputted from the sound source portion 13, to an ultrasonic frequency; and a recording-use amplifier 16 that drives the recording-use ultrasonic wave speaker 6.

The recording-use ultrasonic wave speaker 6 generates an aerial vibration of a frequency (not less than 20 kHz) higher than a human being's audible frequency band. Without need to be limited to the above, for example, the speaker 6 may use several ultrasonic wave generation elements which generate ultrasonic waves. The several ultrasonic wave generation elements are collectively arranged, e.g., in a support plate, and mounted as a speaker array. A detailed example of the ultrasonic wave generation elements is a small-sized piezo-electric loudspeaker suitable for generating ultrasonic waves. The piezoelectric loudspeaker includes a piezo-electric element that is extended and contracted according to an applied voltage (charge and discharge), and a diaphragm that is driven by expansion and contraction of the piezo-electric element to thereby generate waves of condensation and rarefaction in air.

The recording-use sound source portion 13 is a personal computer which contains a memory or program which can generate “several speech signals”, for example. For instance, the recording-use sound source portion 13 can output the following speech signals (information on orientation).
“Please be cautious about the front.”
“Please be cautious about the right front.”
“Please be cautious about the right.”
“Please be cautious about the right rear.”
“Please be cautious about the rear.”
“Please be cautious about the left rear.”
“Please be cautious about the left.”
“Please be cautious about the left front.”

The recording signal output portion 14 is a controller such as a keyboard to output a “specific speech signal” from the recording-use sound source portion 13.

The recording-use ultrasonic modulator 15 ultrasonic modulates a “speech signal” outputted by the recording-use sound source portion 13. The recording-use ultrasonic modulator 15 uses, for example, an AM modulation (amplitude modulation), which modulates an outputted signal of the recording-use sound source portion 13 to an “amplitude change (increase and decrease change in an voltage) at a predetermined ultrasonic frequency (for example, 25 kHz).” It is noted that the ultrasonic modulation is not limited to the AM modulation, and may use another ultrasonic modulation technology such as a PWM modulation (Pulse Width Modulation).

The recording-use amplifier 16 (for example, B class amplifier or D class amplifier) drives the recording-use ultrasonic wave speaker 6, based on an ultrasonic signal modulated by the recording-use ultrasonic modulator 15; it generates or radiates an ultrasonic wave, which is generated by modulating a “speech signal,” towards the dummy head 1.

As the ultrasonic wave radiated towards the dummy head 1 propagates in the air, the ultrasonic wave having a short wavelength is distorted and smoothed by virtue of the viscosity of the air, etc. Thereby, the amplitude components contained in the ultrasonic wave undergoes a self-demodulation during the propagating in the air, resulting in being reproduced as a “speech signal” at the dummy head 1. That is, the ultrasonic modulated sound obtained by ultrasonic modulating “speech signal” can be given to the dummy head 1 via the recording-use ultrasonic wave speaker 6.

(Explanation of the Recorder 12)

The recorder 12 is a digital-type recording apparatus, e.g., a personal computer, which stores (i.e., records), in the memory 17, the “speech signals (sounds used for recording)” having two channels captured via the left and right microphone units 3L, 3R of the dummy head 1. The “speech signals” of the two channels captured by the left and right microphone units 3L, 3R are stored in mutually independent addresses of the memory 17, respectively.

(Explanation of the Recording Method)

The recording-use ultrasonic wave speaker 6 is arranged so as to radiate ultrasonic waves towards an approximately central portion of the dummy head 1. It is noted that it is desirable to record in a place having little reverberation such as a silent room. In addition, a single ultrasonic wave speaker 6 may be used, or the ultrasonic wave speaker 6 may be configured of more than one speaker unit (i.e., sub-speaker).

(a) In the recording of “please be cautious about the front,” the ultrasonic wave speaker 6 is arranged on the front side viewed from the dummy head 1 for recording; the sound recording is recorded in the memory 17. Thereby, the memory 17 stores the binaural recording which sounds “please be cautious about the front” from the front side.

(b) In the recording of “please be cautious about the right front,” the ultrasonic wave speaker 6 is arranged on the right front side viewed from the dummy head 1 for recording; the sound recording is recorded in the memory 17. Thereby, the memory 17 stores the binaural recording which sounds “please be cautious about the right front” from the right front side.

(c) In the recording of “please be cautious about the right,” the ultrasonic wave speaker 6 is arranged on the right side viewed from the dummy head 1 for recording; the sound recording is recorded in the memory 17. Thereby, the memory 17 stores the binaural recording which sounds “please be cautious about the right” from the right side.

(d) In the recording of “please be cautious about the right rear,” the ultrasonic wave speaker 6 is arranged on the right rear side viewed from the dummy head 1 for recording; the sound recording is recorded in the memory 17. Thereby, the memory 17 stores the binaural recording which sounds “please be cautious about the right rear” from the right rear side.

(e) In the recording of “please be cautious about the rear,” the ultrasonic wave speaker 6 is arranged on the rear side viewed from the dummy head 1 for recording; the sound recording is recorded in the memory 17. Thereby, the memory 17 stores the binaural recording which sounds “please be cautious about the rear” from the rear side.

(f) In the recording of “please be cautious about the left rear,” the ultrasonic wave speaker 6 is arranged on the left rear side viewed from the dummy head 1 for recording; the sound recording is recorded in the memory 17. Thereby, the memory 17 stores the binaural recording which sounds “please be cautious about the left rear” from the left rear side.

(g) In the recording of “please be cautious about the left,” the ultrasonic wave speaker 6 is arranged on the left side viewed from the dummy head 1 for recording; the sound recording is recorded in the memory 17. Thereby, the memory 17 stores the binaural recording which sounds “please be cautious about the left” from the left side.

(h) In the recording of “please be cautious about the left front,” the ultrasonic wave speaker 6 is arranged on the left front side viewed from the dummy head 1 for recording; the sound recording is recorded in the memory 17. Thereby, the memory 17 stores the binaural recording which sounds “please be cautious about the left front” from the left front side.

(Explanation of the Sound Apparatus for Vehicles)

The caution apparatus of this example includes the following: (i) a reproducing-use sound source portion 4 that contains a memory 21 storing the eight “speech signals (the two-channel binaural recording recorded using the dummy head 1),” which were stored in the memory 17 using the above-mentioned recording method; (ii) a two-channel reproduction portion 5 to reproduce the binaural recording stored in the reproducing-use sound source portion 4; and (iii) a caution monitor portion 22 that outputs a “specific speech signal” via the reproducing-use sound source portion 4.

The caution monitor portion 22 includes the following: a monitor section (image analysis section using an ultrasonic sonar, a CCD camera, etc.) to monitor a circumferential state of the vehicle; a caution orientation determination section to determine in which orientation of the vehicle a caution target occurred from the monitored result by the monitor section; and a reproduction signal instruction section to instruct the reproducing-use sound source portion 4 to output a “specific speech signal (two-channel speech signal by the binaural recording)” based on a determination result of the caution orientation determination section. The caution monitor portion 22 indicated in this example is for the explanation to help understanding, and can be changed variously.

In specific, the reproduction signal instruction section to cause the reproducing-use sound source portion 4 to output as follows.

(a) Outputting the two-channel speech signal of binaural recording “please be cautious about the front” when the caution orientation determination section determines that the caution target occurred on the front side viewed from the driver.

(b) Outputting the two-channel speech signal of binaural recording “please be cautious about the right front” when the caution orientation determination section determines that the caution target occurred on the right front side viewed from the driver.

(c) Outputting the two-channel speech signal of binaural recording “please be cautious about the right” when the caution orientation determination section determines that the caution target occurred on the right side viewed from the driver.

(d) Outputting the two-channel speech signal of binaural recording “please be cautious about the right rear” when the caution orientation determination section determines that the caution target occurred on the right rear side viewed from the driver.

(e) Outputting the two-channel speech signal of binaural recording “please be cautious about the rear” when the caution orientation determination section determines that the caution target occurred on the rear side viewed from the driver.

(f) Outputting the two-channel speech signal of binaural recording “please be cautious about the left rear” when the caution orientation determination section determines that the caution target occurred on the left rear side viewed from the driver.

(g) Outputting the two-channel speech signal of binaural recording “please be cautious about the left” when the caution orientation determination section determines that the caution target occurred on the left side viewed from the driver.

(h) Outputting the two-channel speech signal of binaural recording “please be cautious about the left front” when the caution orientation determination section determines that the caution target occurred on the left front side viewed from the driver.

(Explanation of the Two-Channel Reproduction Portion 5)

The two-channel reproduction portion 5 gives a two-channel speech (binaural recording: information on orientation) to the driver using the two-channel parametric speaker, and includes the following: a reproducing-use ultrasonic wave speaker 7 including left and right speaker units 7L, 7R, which generate ultrasonic waves towards the left ear and the right ear of the driver, respectively; a reproducing-use ultrasonic modulator 23 including left and right modulator units 23L, 23R, which modulate the two-channel “speech signal” outputted from the reproducing-us sound source portion 4 to an ultrasonic frequency; and a reproducing-use two-channel amplifier 24 including left and right amplifier units 24L, 24R, which drive the left and right reproducing-use ultrasonic wave speaker units 7L, 7R (several ultrasonic wave generation elements), respectively.

The left and right reproducing-use ultrasonic wave speaker units 7L, 7R generate an aerial vibration of a frequency (not less than 20 kHz) higher than a human being's audible frequency band. The basic configuration may be the same as that of the recording-use ultrasonic wave speaker 6 or different from that of the recording-use ultrasonic wave speaker 6 (for example, ribbon speaker).

The left and right ultrasonic wave speaker units 7L, 7R radiate the ultrasonic waves towards the left and right ears of the driver, respectively. As a detailed example of the arrangement, FIG. 1B illustrates an example arranged in a vehicle seat 25 (a headrest or an upper part of a backrest). The arrangement position of the ultrasonic wave speaker units 7L, 7R are not limited to the vehicle seat 25. They may be arranged on a dashboard such as on the sides of a meter panel, on the both-side pillars of the windshield, on the ceiling of the vehicle, or the like.

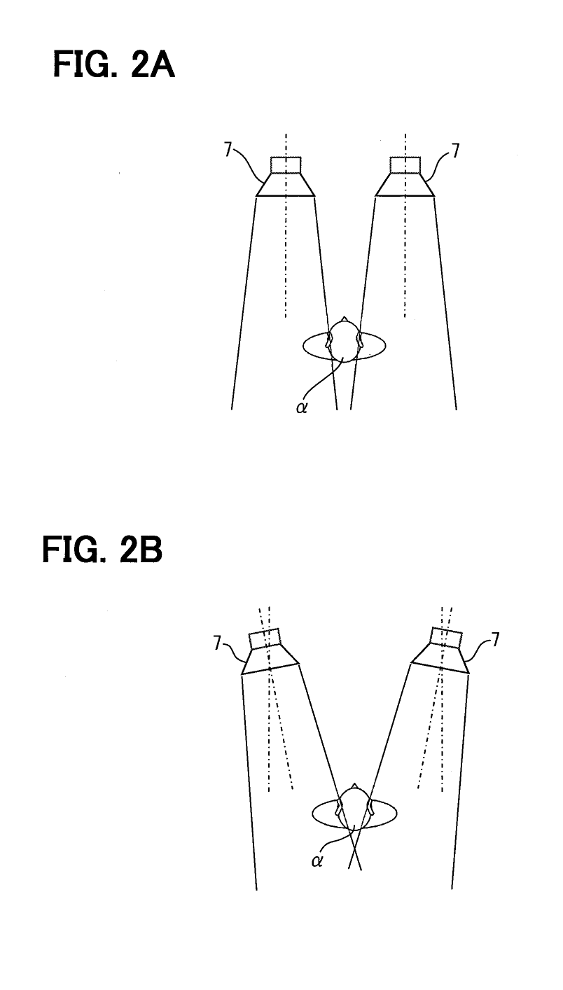

In addition, as the left and right ultrasonic wave speaker units 7L, 7R are not arranged in a parallel arrangement in FIG. 2A such that the both radiation axes are parallel with each other; instead, they are arranged in an inward swing arrangement in FIG. 2B such that the both radiation axes are directed, towards the driver, inward from the parallel arrangement. In specific, the radiation axes of the ultrasonic waves of the left and right ultrasonic wave speaker units 7L, 7R intersect on a position on the driver side; the intersecting position may be at a position on the front side viewed from the driver, at a position in the head of the driver, or at a position on the rear side viewed from the driver.

The left and right modulator units 23L, 23R of the two-channel reproducing-use ultrasonic modulator 23 ultrasonic modulate two channels of the “speech signal” outputted by the reproducing-use sound source portion 4, respectively. As a detailed example, the reproducing-use ultrasonic modulator 23 uses an AM modulation (amplitude modulation), which modulates an outputted signal of the reproducing-use sound source portion 4 to an “amplitude change (increase and decrease change in an voltage) at a predetermined ultrasonic frequency (for example, 25 kHz).” It is noted that the ultrasonic modulation is not limited to the AM modulation, and may use another ultrasonic modulation technology such as a PWM modulation (Pulse Width Modulation).

The left and right amplifier units 24L, 24R of the reproducing-use two-channel amplifier 24 (for example, B class amplifier or D class amplifier) drive the left and right ultrasonic wave speaker units 7L, 7R based on the ultrasonic signals modulated in the ultrasonic modulator units 23L, 23R of the two channels, respectively. The left and right amplifier units 24L, 24R generate the ultrasonic waves, which are obtained by modulating the “speech signals,” from the left and right speaker units 7L, 7R towards the left and right ears of the driver.

As the ultrasonic waves radiated towards the left and right ears of the driver propagates in the air, the ultrasonic waves having short wavelengths are distorted and smoothed by virtue of the viscosity of the air, etc. Thereby, the amplitude components contained in the ultrasonic waves undergo a self-demodulation during the propagating in the air, resulting in being reproduced as “speech signals” at the left and right ears of the driver. Alternatively, the ultrasonic waves reaching the head a (i.e., near each ear) of the driver before being demodulated is self-demodulated in the head a of the driver; thereby, the “speeches” are reproduced in the left and right ears of the driver, respectively.

The detailed operations are as follows.

(a) The speech signal of “please be cautious about the front” is outputted from the reproducing-use sound source portion 4 when the caution orientation determination section determines that the caution target occurred on the front side viewed from the driver. Thereby, the speech of “please be cautious about the front” is localized at a position on the front side viewed from the driver.

(b) The speech signal of “please be cautious about the right front” is outputted from the reproducing-use sound source portion 4 when the caution orientation determination section determines that the caution target occurred on the right front side viewed from the driver. Thereby, the speech of “please be cautious about the right front” is localized at a position on the right front side viewed from the driver.

(c) The speech signal of “please be cautious about the right” is outputted from the reproducing-use sound source portion 4 when the caution orientation determination section determines that the caution target occurred on the right side viewed from the driver. Thereby, the speech of “please be cautious about the right” is localized at a position on the right side viewed from the driver.

(d) The speech signal of “please be cautious about the right rear” is outputted from the reproducing-use sound source portion 4 when the caution orientation determination section determines that the caution target occurred on the right rear side viewed from the driver. Thereby, the speech of “please be cautious about the right rear” is localized at a position on the right rear side viewed from the driver.

(e) The speech signal of “please be cautious about the rear” is outputted from the reproducing-use sound source portion 4 when the caution orientation determination section determines that the caution target occurred on the rear side viewed from the driver. Thereby, the speech of “please be cautious about the rear” is localized at a position on the rear side viewed from the driver.

(f) The speech signal of “please be cautious about the left rear” is outputted from the reproducing-use sound source portion 4 when the caution orientation determination section determines that the caution target occurred on the left rear side viewed from the driver. Thereby, the speech of “please be cautious about the left rear” is localized at a position on the left rear side viewed from the driver.

(g) The speech signal of “please be cautious about the left” is outputted from the reproducing-use sound source portion 4 when the caution orientation determination section determines that the caution target occurred on the left side viewed from the driver. Thereby, the speech of “please be cautious about the left” is localized at a position on the left side viewed from the driver.

(h) The speech signal of “please be cautious about the left front” is outputted from the reproducing-use sound source portion 4 when the caution orientation determination section determines that the caution target occurred on the left front side viewed from the driver. Thereby, the speech of “please be cautious about the left front” is localized at a position on the left front side viewed from the driver.

[Effect 1 of First Example]

The binaural recording (recording product) stored in the reproducing-use sound source portion 4 is recorded by giving the ultrasonic modulated sound, which is obtained by ultrasonic modulating a speech (speech information on orientation), from the recording-use ultrasonic wave speaker 6 to the dummy head 1. Since the directionality of the ultrasonic wave is strong, the diffusion of the sound is suppressed; thereby, the sound used for recording may be given pinpoint to the dummy head 1. That is, highly precise “sonic 3D information (localization information)” can be given to the left and right microphone units 3L, 3R in the left and right ears of the dummy head 1, respectively. This results in obtaining the binaural recording (recording product) providing a significantly high accurate localization of the pronunciation orientation, as compared with a conventional binaural recording. An accurate “sonic three-dimensional localization” becomes possible even in a vehicle compartment tending to contain reflected sounds or muffled sounds.

[Effect 2 of First Example]

The two-channel reproduction portion 5 again ultrasonic modulates the binaural recording stored in the reproducing-use sound source portion 4 to generate ultrasonic modulated sounds, as mentioned above; the portion 5 gives the ultrasonic modulated sounds towards the left and right ears of the driver from the left and right ultrasonic wave speaker units 7L, 7R, arranged at positions distant from the head a of the driver, respectively. Since the directionality of the ultrasonic waves is strong, the diffusion of the sounds is suppressed; thereby, the “recorded sound” may be given pinpoint to each of the left and right ears. That is, even in a vehicle compartment tending to have reflected sounds or muffled sounds, the “sonic 3D information” may be accurately reproduced at each of the left and right ears of the driver.

Thus, even when the “position of the speaker 7 (in specific, the positions of the ultrasonic wave speaker units 7L, 7R)” is distant from the left and right “ears” of the driver, the “sonic 3D information” included in the binaural recording is accurately reproducible at each of the left and right “ears” of the driver. Thereby, in a vehicle compartment tending to have reflected sounds or muffled sounds, even without using a headphone, the pronunciation orientation may be localized freely at an arbitrary position. That is, even when the “position of the speaker” and the “ear” are separated distant from each other in a vehicle compartment being apt to suffer from reflected sounds or muffled sounds, the “sonic three-dimensional localization” is accurately reproducible.

[Effect 3 of First Example]

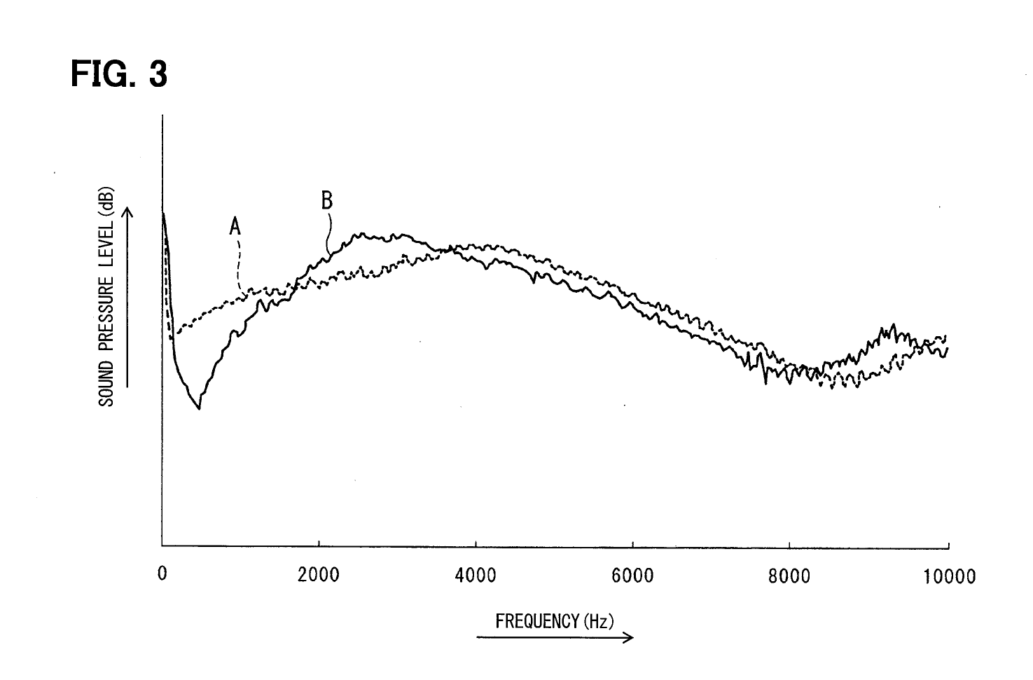

As explained above, the dummy head 1 used for the binaural recording is provided with the dummy ear pinnas 2La, 2Ra and dummy external auditory canals 2Lb, 2Rb; the left and right microphone units 3L, 3R are arranged inside of the dummy external auditory canals 2Lb, 2Rb, respectively. Thereby, the “sound used for recording” is recorded using the left and right microphone units 3L, 3R in the state including the influence of the ear pinnas and the external auditory canals. In specific, in the case of using a general dummy head 1 not having the dummy ear pinnas 2La, 2ra and dummy external auditory canals 2Lb, 2Rb, a frequency characteristic, which does not have the influence of the external ears (ear pinnas+external auditory canals), appears, as illustrated in a broken line A of FIG. 3. This may provide a disadvantage not to provide accurate “sonic 3D information.”

In contrast, since the dummy head 1 of this example has the dummy ear pinnas 2La, 2ra and dummy external auditory canals 2Lb, 2Rb, a frequency characteristic containing the influence of the external ears (ear pinnas+external auditory canals) appears, as illustrated in a solid line B of FIG. 3. This may achieve the accurate recording of “sonic 3D information.” Thus, providing the dummy ear pinnas 2La, 2Ra and dummy external auditory canals 2Lb, 2Rb to the dummy head 1 can improve the accuracy of “sonic 3D information” included in the binaural recording. As a result, the accuracy of the “sonic three-dimensional localization” given to the driver can be raised.

[Effect 4 of First Example]

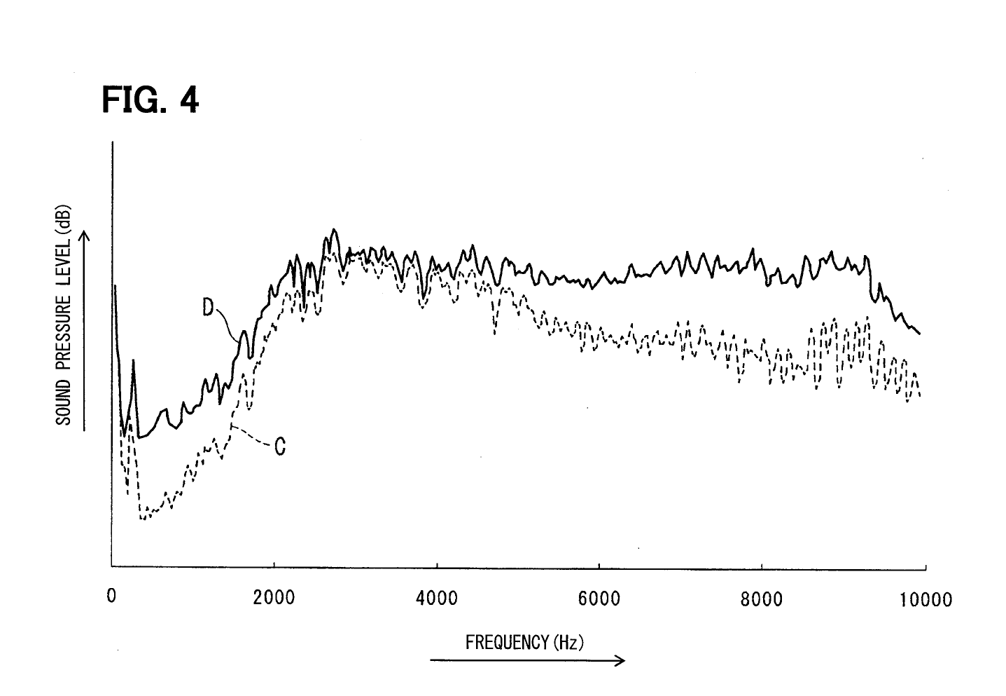

As mentioned above, the speaker units 7L, 7R of the reproducing-use ultrasonic wave speaker 7 are arranged in an inward swing arrangement. Thereby, the ultrasonic modulated sounds, which are radiated from the left and right ultrasonic wave speaker units 7L, 7R, reach the eardrums while suppressing the influence of the external auditory canals of the driver. The accuracy of “sonic 3D information” given to the “eardrums” can be raised. When the left and right ultrasonic wave speaker units 7L, 7R are arranged in a parallel arrangement, (i) the heading direction (i.e., radiation axis) of each ultrasonic wave and (ii) each external auditory canal are orthogonal to each other. The low frequency band such as 2 kHz or less may not reach the eardrum, as illustrated in the broken line C of FIG. 4. This may provide a disadvantage not to provide accurate “sonic 3D information.”

In contrast, the left and right ultrasonic wave speaker units 7L, 7R of this example are arranged in an inward swing arrangement, part of the ultrasonic wave reaches each the inside of the external auditory canal. The low frequency band such as 2 kHz or less may reach the eardrum to the higher extent, as illustrated in the solid line D of FIG. 4. This may provide the accurate “sonic 3D information” to the driver. Therefore, even when the reproducing-use ultrasonic wave speaker 7 is distant from the head a of the driver, the configuration of the first example can achieve a state that is approximately comparable with a state where a headphone is used to radiate a sound to an eardrum. The accuracy of “the sonic three-dimensional localization” in the three-dimensional sound apparatus which does not use any headphone can be raised.

[Effect 5 of First Example]

The present disclosure achieves the “three-dimensional localization of a sound” without using a headphone, thus enabling an arrangement in a vehicle. Furthermore, in this example, the “information on orientation” is provided to the driver, thereby enabling the driver to quickly recognize the orientation where the information is provided, and shortening the “recognition time of the orientation.” Therefore, the caution capability of the driver can be increased. In detail, it becomes possible to warn the driver of the dangerous place accurately with the localized orientation of the sound. The misapprehension of the driver can be prevented; thus, the safety can be improved.

### Second Example

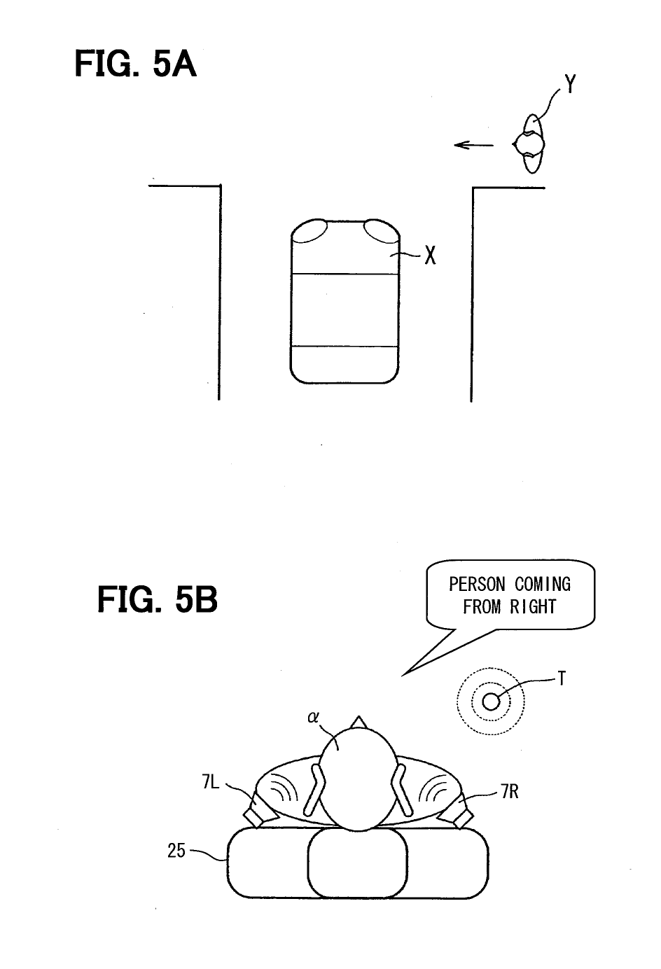

A second example will be explained with reference to FIGS. 5A, 5B. In the above first example, the following three orientations accord with each other: (i) the “occurrence orientation (e.g., right front) of a caution target” which the caution orientation determination section determines; (ii) the sonic orientation (e.g., right front) that is localized or recognized by the driver; and (iii) the orientation (e.g., right front) indicated by the content of the announcement about the “information on orientation” in the speech signal. That is, the “determination orientation,” the “localization orientation,” and the “announcement orientation” accord with each other thoroughly.

Without need to be limited thereto, a part of the “determination orientation,” the “localization orientation,” and the “announcement orientation” may be differentiated.

With reference to FIGS. 5A, 5B, (i) as illustrated in FIG. 5A, the caution orientation determination section determines that a pedestrian Y approaches the “right front” side viewed from a subject vehicle X that adopts the present example; (ii) the sound is localized at a position on the “right front” side viewed from the driver, as illustrated in FIG. 5B as a virtual sound source T (a localized sonic position, which is generated by the two-channel reproduction portion 5 and recognized by the driver); and (iii) “a person coming from the right (instead of the right front)” is announced using the speech signal.

Thus, the caution information occurring on the “right front” is indicated by simply announcing “right.” The user's understanding and determination can be made quickly; thus, the caution capability of the driver can be raised.

### Third Example

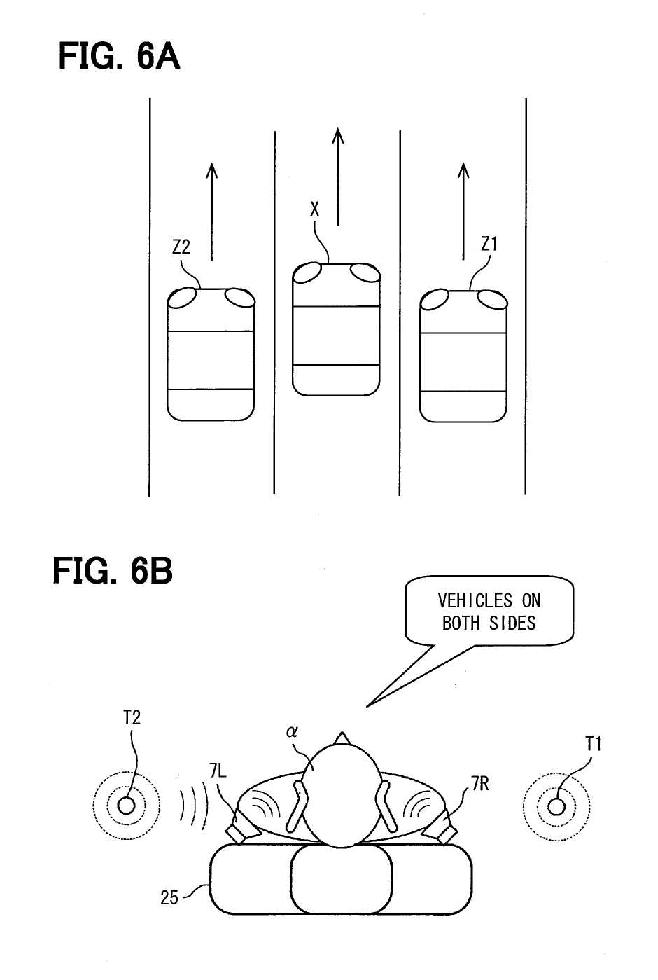

A third example will be explained with reference to FIGS. 6A, 6B. The first and second examples provide the user with “localization of a single sound.” That is, the user is provided with a single virtual sound source T having only one of several orientations. Without need to be limited thereto, the user may be simultaneously provided with several virtual sound sources having mutually different orientations.

With reference to FIGS. 6A, 6B, suppose the case where a driver of a subject vehicle X containing the vehicular sound apparatus (caution apparatus) of this example starts a preparation action for changing a traveling traffic lane such as flashing a turn signal during traveling. In this case, (i) as illustrated in FIG. 6A, the caution orientation determination section determines (a) a parallel traveling vehicle Z1 traveling parallel on the right side viewed from the subject vehicle X, and (b) a parallel traveling vehicle Z2 traveling parallel on the left side viewed from the subject vehicle X; (ii) the sounds are localized at positions on the “both left and right” sides viewed from the driver, as illustrated in FIG. 6B as virtual sound sources T1, T2 (localized sonic positions, which are generated by the two-channel reproduction portion 5 and recognized by the driver); and (iii) “vehicles are existing on both the sides (an example of information on orientation)” is announced using the speech signal from each of the virtual sound sources T1, T2.

Thus, “several caution informations (caution information items) occurring simultaneously” are “localized at several orientations”; then, the “information on several orientations (vehicles are existing on both the sides)” is announced. This enables the user to quickly understand and determine several caution informations occurring simultaneously, thereby raising the caution capability of the driver. In this example, the travel state surrounding the subject vehicle X can be specifically known using the auditory information. The safe changing of the traffic lane is enabled while danger is avoided.

### Fourth Example

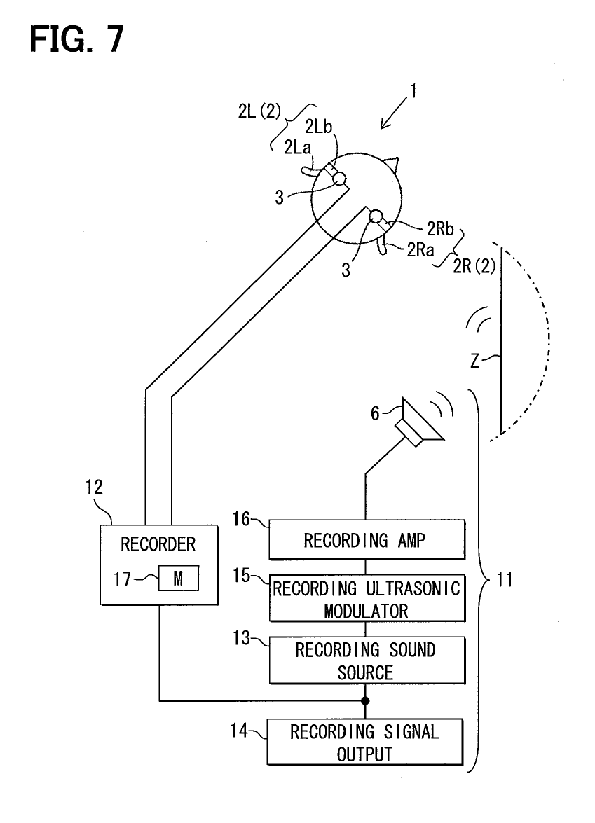

A fourth example will be explained with reference to FIG. 7. In the above first example, the binaural recording stored in the reproducing-use sound source portion 4 is recorded by directly radiating, to the dummy head 1, the ultrasonic modulated sound (ultrasonic wave obtained by modulating the audible sound to the ultrasonic frequency) generated from the recording-use ultrasonic wave speaker 6. In contrast, in this fourth example, the binaural recording stored in the reproducing-use sound source portion 4 includes a recording product which is obtained by (i) radiating, to a reflection target Z, the ultrasonic modulated sound generated from the recording-use ultrasonic wave speaker 6, and (ii) recording a reflected sound from the reflection target Z.

(Explanation of the Binaural Recording of the Reflected Sound)

An example of the recording technology of the reflected sound will be explained with reference to FIG. 7. In this example, the reflection target Z is assumed to be a dummy parallel traveling vehicle Z. There is no need to be limited thereto. In the fourth example, the following binaural recording is executed independent of the binaural recording indicated in the first example.

The recording-use sound source portion 13 may generate a base sound such as a vehicular road noise other than the “several speech signals (announcements),” for recording the reflected sound. The dummy head 1, the recording-use ultrasonic wave speaker 6, and the dummy parallel traveling vehicle Z (reflection target) have a positional relation such that the reflected sound reflected by the dummy parallel traveling vehicle Z is radiated towards an approximately central position of the dummy head 1.

(a) In the recording for localizing a virtual sound source (a reflected sound of the dummy parallel traveling vehicle Z) at a position on the right side viewed from the driver, the dummy head 1, the recording-use ultrasonic wave speaker 6, and the dummy parallel traveling vehicle Z (reflection target) have a positional relation such that the reflected sound reflected by the dummy parallel traveling vehicle Z is directed at a right surface of the dummy head 1, thereby performing the binaural recording.

(b) In the recording for localizing a virtual sound source (a reflected sound of the dummy parallel traveling vehicle Z) at a position on the right rear side viewed from the driver, the dummy head 1, the recording-use ultrasonic wave speaker 6, and the dummy parallel traveling vehicle Z (reflection target) have a positional relation such that the reflected sound reflected by the dummy parallel traveling vehicle Z is directed at a right rear surface of the dummy head 1, thereby performing the binaural recording.

(c) In the recording for localizing a virtual sound source (a reflected sound of the dummy parallel traveling vehicle Z) at a position on the left side viewed from the driver, the dummy head 1, the recording-use ultrasonic wave speaker 6, and the dummy parallel traveling vehicle Z (reflection target) have a positional relation such that the reflected sound reflected by the dummy parallel traveling vehicle Z is directed at a left surface of the dummy head 1, thereby performing the binaural recording.

(d) In the recording for localizing a virtual sound source (a reflected sound of the dummy parallel traveling vehicle Z) at a position on the left rear side viewed from the driver, the dummy head 1, the recording-use ultrasonic wave speaker 6, and the dummy parallel traveling vehicle Z (reflection target) have a positional relation such that the reflected sound reflected by the dummy parallel traveling vehicle Z is directed at a left rear surface of the dummy head 1, thereby performing the binaural recording.

(Explanation of the Binaural Recording of the Speech Announcement about Orientation)

Furthermore, in the present fourth example, the recording method performs the following: (a′) the binaural recording of “a vehicle is existing in the right side” which performs a sound image localization on the right side viewed from the driver; (b′) the binaural recording of “a vehicle is existing in the right rear side” which performs a sound image localization on the right rear side viewed from the driver; (c′) the binaural recording of “a vehicle is existing in the left side” which performs a sound image localization on the left side viewed from the driver; and (d′) the binaural recording of “a vehicle is existing in the left rear side” which performs a sound image localization on the left rear side viewed from the driver.

(Explanation of the Reproduction Technique of the Reflected Sound)

The basic configuration of the caution apparatus of the fourth example is the same as that of the first example and includes a reproducing-use sound source portion 4 and a two-channel reproduction portion 5. The reproducing-use sound source portion 4 of the fourth example stores the following: (a′) the binaural recording of “a vehicle is existing in the right side” which performs a sound image localization on the right side viewed from the driver; (b′) the binaural recording of “a vehicle is existing in the right rear side” which performs a sound image localization on the right rear side viewed from the driver; (c′) the binaural recording of “a vehicle is existing in the left side” which performs a sound image localization on the left side viewed from the driver; (d′) the binaural recording of “a vehicle is existing in the left rear side” which performs a sound image localization on the left rear side viewed from the driver; (a) the binaural recording of “reflected sounds of the dummy parallel traveling vehicle Z” which performs a sound image localization on the right side viewed from the driver; (b) the binaural recording of “reflected sounds of the dummy parallel traveling vehicle Z” which performs a sound image localization on the right rear side viewed from the driver; (c) the binaural recording of “reflected sounds of the dummy parallel traveling vehicle Z” which performs a sound image localization on the left side viewed from the driver; and (d) the binaural recording of “reflected sounds of the dummy parallel traveling vehicle Z” which performs a sound image localization on the left rear side viewed from the driver.

The two-channel reproduction portion 5 of the fourth example applies an ultrasonic modulation to the “binaural recording of the speech announcement about orientation” and the “binaural recording of the reflected sounds,” which are stored in the reproducing-use sound source portion 4, simultaneous or consecutively (or alternately). The two-channel reproduction portion 5 provides the ultrasonic modulated sounds towards the left and right ears of the driver from the reproducing-use ultrasonic wave speaker units 7L, 7R, respectively.

Next, a detailed example of reproduction or operation of the reflected sound by the caution apparatus will be explained. The following indicates an example to reproduce simultaneously the “speech announcement (binaural recording) about orientation” and the “reflected sound (binaural recording).” There is no need to be limited thereto; both the binaural recordings may be reproduced independently.

(a) Suppose the case where a driver of a subject vehicle X starts a preparation action for changing a traveling traffic lane to the right such as flashing a right turn signal during traveling. When the caution orientation determination section of the caution monitor portion 22 determines a parallel travel vehicle on the right side viewed from the vehicle X, the reproducing sound source portion 4 mixes (i) the binaural recording of “a vehicle is existing in the right side” which performs a sound image localization on the right side viewed from the vehicle, and (ii) the binaural recording of “reflected sound by the dummy parallel traveling vehicle Z” which performs a sound image localization on the right side viewed from the vehicle X, thereby outputting the mixed sounds. Then, the binaural recordings are reproduced by the parametric speakers of the left and right ultrasonic wave speaker units 7L, 7R; “a vehicle is existing on the right side” and “reflected sound by the dummy parallel traveling vehicle Z” are localized at a position on the right side viewed from the driver.

(b) Suppose the case where a driver of a subject vehicle X starts a preparation action for changing a traveling traffic lane to the right such as flashing a right turn signal during traveling. When the caution orientation determination section of the caution monitor portion 22 determines a parallel travel vehicle on the right rear side viewed from the vehicle, the reproducing sound source portion 4 mixes (i) the binaural recording of “a vehicle is existing in the right rear side” which performs a sound image localization on the right rear side viewed from the vehicle X, and (ii) the binaural recording of “reflected sound by the dummy parallel traveling vehicle Z” which performs a sound image localization on the right rear side viewed from the vehicle X, thereby outputting the mixed sounds. Then, the binaural recordings are reproduced by the parametric speakers of the left and right ultrasonic wave speaker units 7L, 7R; “a vehicle is existing on the right rear side” and “reflected sound by the dummy parallel traveling vehicle Z” are localized at a position on the right rear side viewed from the driver.

(c) Suppose the case where a driver of a subject vehicle X starts a preparation action for changing a traveling traffic lane to the left such as flashing a left turn signal during traveling. When the caution orientation determination section of the caution monitor portion 22 determines a parallel travel vehicle on the left side viewed from the vehicle X, the reproducing sound source portion 4 mixes (i) the binaural recording of “a vehicle is existing in the left side” which performs a sound image localization on the left side viewed from the vehicle X, and (ii) the binaural recording of “reflected sound by the dummy parallel traveling vehicle Z” which performs a sound image localization on the left side viewed from the vehicle X, thereby outputting the mixed sounds. Then, the binaural recordings are reproduced by the parametric speakers of the left and right ultrasonic wave speaker units 7L, 7R; “a vehicle is existing on the left side” and “reflected sound by the dummy parallel traveling vehicle Z” are localized at a position on the left side viewed from the driver.

(d) Suppose the case where a driver of a subject vehicle X starts a preparation action for changing a traveling traffic lane to the left such as flashing a left turn signal during traveling. When the caution orientation determination section of the caution monitor portion 22 determines a parallel travel vehicle on the left rear side viewed from the vehicle X, the reproducing sound source portion 4 mixes (i) the binaural recording of “a vehicle is existing in the left rear side” which performs a sound image localization on the left rear side viewed from the vehicle X, and (ii) the binaural recording of “reflected sound by the dummy parallel traveling vehicle Z” which performs a sound image localization on the left rear side viewed from the vehicle X, thereby outputting the mixed sounds. Then, the binaural recordings are reproduced by the parametric speakers of the left and right ultrasonic wave speaker units 7L, 7R; “a vehicle is existing on the left rear side” and “reflected sound by the dummy parallel traveling vehicle Z” are localized at a position on the left rear side viewed from the driver.

[Effect of Fourth Example]

As mentioned above, the caution apparatus of the fourth example reproduces the binaural recording of the reflected sound reflected by the reflection target (dummy parallel traveling vehicle Z etc.), and gives it to the driver. The reflected sound includes the auditory information of the “information on reflection target (for example, the dummy parallel traveling vehicle Z).” Therefore, the reproducing of the reflected sound by the caution apparatus enables the driver to be given the “sonic information on orientation” and the “information on reflection target (for example, the dummy parallel traveling vehicle Z)” using the auditory information. This enables the user to quickly understand and determine the reflection target using the auditory information, consequently raising the caution capability of the driver.

It is noted that the information on reflection target may include information on distance, shape, magnitude, and/or material of the reflection target.

It is known that a visually impaired person acquires information on reflection target, which is similar to visual information, from a reflected sound that is generated when a slapping sound by a stick or the like is reflected from a periphery. A healthy person gives a priority to the visual information; thus, the healthy person does not usually acquire, from the reflected sound, the information on reflection target similar to the visual information. However, even the healthy person has an auditory capability similar to that of the visually impaired person. Therefore, the information on reflection target similar to the visual information may be acquired from “the reflected sound reflected by the reflection target” using the caution apparatus. Otherwise, a user such as a driver hears repeatedly “the reflected sound reflected by the reflection target” using the caution apparatus; thereby, the user becomes enabled to acquire, from the reflected sound, the information on reflection target similar to the visual information.

Thus, the reflection target may be differentiated from the dummy parallel traveling vehicle Z. Even in the case that the reflection target is different from the dummy parallel traveling vehicle Z, the reflected sound of the reflection target may be reproduced in the caution apparatus. Thereby, the user is enabled to understand the reflection target quickly using the auditory information due to the reflected sound.

The above examples may be combined in various manners. For instance, the third example and the fourth example may be combined. That is, when the parallel traveling vehicles Z1, Z2 are in both the sides viewed from the subject vehicle X, the “reflected sound by the dummy parallel traveling vehicle Z” may be localized at the virtual sound sources T1, T2.

In the above examples, the present disclosure is applied to the caution apparatus for vehicles. Without need to be limited thereto, it may be applied to a navigation apparatus; thereby, an occupant may be provided with “information on orientation.”

In the above examples, the speech information is provided to an occupant of a vehicle. Without need to be limited thereto, the present disclosure may be applied to a vehicular audio apparatus, which gives music to an occupant of a vehicle.

In the above examples, the three-dimensional sound apparatus is mounted in a vehicle. There is no need to be limited thereto. The present disclosure may be applied to a sound apparatus (apparatus which generates sounds such as speeches or music) arranged in a small space (space tending to provide reflected sounds or muffled sounds) other than the vehicle compartment.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A three-dimensional sound apparatus in a small space including a vehicular compartment tending to provide reflected sounds or muffled sounds,
the three-dimensional sound apparatus comprising:
a reproducing-use sound source portion that stores binaural recording of two channels; and
a two-channel reproduction portion that reproduces the binaural recording of two channels stored in the reproducing-use sound source portion,
wherein
the binaural recording stored in the reproducing-use sound source portion is recorded by generating, from a recording-use ultrasonic wave speaker, an ultrasonic modulated sound that is obtained by applying an ultrasonic modulation to an audible sound; and
the two-channel reproduction portion
applies an ultrasonic modulation to the binaural recording stored in the reproducing-use sound source portion to obtain ultrasonic modulated sounds, and
gives the ultrasonic modulated sounds towards left and right ears of a user from left and right reproducing-use ultrasonic wave speaker units arranged at positions distant from a head of the user, respectively.

2. The three-dimensional sound apparatus according to claim 1, wherein:
the binaural recording stored in the reproducing-use sound source portion includes a recording product recorded using left and right microphone units arranged at left and right dummy ears of a dummy head which imitates a human being's head;
the left and right dummy ears of the dummy head are provided with left and right dummy external auditory canals, respectively; and
the left and right microphone units are arranged inside of the dummy external auditory canals.

3. The three-dimensional sound apparatus according to claim 2,
wherein the left and right reproducing-use ultrasonic wave speaker units are provided to radiate ultrasonic sounds towards the user in an inward swing arrangement where radiation axes of the left and right reproducing-use ultrasonic wave speaker units are directed inward of parallel lines, towards the user.

4. The three-dimensional sound apparatus according to claim 1,
wherein the left and right reproducing-use ultrasonic wave speaker units are provided to radiate ultrasonic sounds towards the user in an inward swing arrangement where radiation axes of the left and right reproducing-use ultrasonic wave speaker units are directed inward of parallel lines, towards the user.

5. The three-dimensional sound apparatus according to claim 1, being used for a sound apparatus for a vehicle, the sound apparatus giving information on orientation using a sound to an occupant of the vehicle.

6. The three-dimensional sound apparatus according to claim 5, wherein:
the binaural recording stored in the reproducing-use sound source portion includes a recording product that is recorded by
(i) directing an ultrasonic modulated sound generated from the recording-use ultrasonic wave speaker to a reflection target, and
(ii) recording a reflected sound, which is reflected by the reflection target, as binaural recording;
the two-channel reproduction portion applies an ultrasonic modulation to the binaural recording of the reflected sound stored in the reproducing-use sound source portion to obtain ultrasonic modulated sounds; and
the two-channel reproduction portion gives the ultrasonic modulated sounds towards the left and right ears of the user from the left and right reproducing-use ultrasonic wave speaker units arranged at the positions distant from the head of the user, respectively.

7. The three-dimensional sound apparatus according to claim 1, wherein:
the binaural recording stored in the reproducing-use sound source portion includes a recording product that is recorded by
(i) directing an ultrasonic modulated sound generated from the recording-use ultrasonic wave speaker to a reflection target, and
(ii) recording a reflected sound, which is reflected by the reflection target, as binaural recording;
the two-channel reproduction portion applies an ultrasonic modulation to the binaural recording of the reflected sound stored in the reproducing-use sound source portion to obtain ultrasonic modulated sounds; and
the two-channel reproduction portion gives the ultrasonic modulated sounds towards the left and right ears of the user from the left and right reproducing-use ultrasonic wave speaker units arranged at the positions distant from the head of the user, respectively.

8. The three-dimensional sound apparatus according to claim 2, being used for a sound apparatus for a vehicle, the sound apparatus giving information on orientation using a sound to an occupant of the vehicle.

9. The three-dimensional sound apparatus according to claim 4, being used for a sound apparatus for a vehicle, the sound apparatus giving information on orientation using a sound to an occupant of the vehicle.

10. The three-dimensional sound apparatus according to claim 2, wherein:
the binaural recording stored in the reproducing-use sound source portion includes a recording product that is recorded by
(i) directing an ultrasonic modulated sound generated from the recording-use ultrasonic wave speaker to a reflection target, and
(ii) recording a reflected sound, which is reflected by the reflection target, as binaural recording;
the two-channel reproduction portion applies an ultrasonic modulation to the binaural recording of the reflected sound stored in the reproducing-use sound source portion to obtain ultrasonic modulated sounds; and
the two-channel reproduction portion gives the ultrasonic modulated sounds towards the left and right ears of the user from the left and right reproducing-use ultrasonic wave speaker units arranged at the positions distant from the head of the user, respectively.

11. The three-dimensional sound apparatus according to claim 4, wherein:
the binaural recording stored in the reproducing-use sound source portion includes a recording product that is recorded by
(i) directing an ultrasonic modulated sound generated from the recording-use ultrasonic wave speaker to a reflection target, and
(ii) recording a reflected sound, which is reflected by the reflection target, as binaural recording;
the two-channel reproduction portion applies an ultrasonic modulation to the binaural recording of the reflected sound stored in the reproducing-use sound source portion to obtain ultrasonic modulated sounds; and
the two-channel reproduction portion gives the ultrasonic modulated sounds towards the left and right ears of the user from the left and right reproducing-use ultrasonic wave speaker units arranged at the positions distant from the head of the user, respectively.
